(19) United States
(12) Patent Application Publication
(10) Pub. No.: US 2021/0117127 A1
(43) Pub. Date: Apr. 22, 2021

(54) EFFICIENT COMMAND QUEUE IN UNIVERSAL FLASH STORAGE (UFS)

(71) Applicant: QUALCOMM Incorporated, San Diego, CA (US)

(72) Inventors: Madhu Yashwanth BOENAPALLI, Hyderabad (IN); Sai Praneeth SREERAM, Anantapur (IN); Surendra PARAVADA, Hyderabad (IN); Venu Madhav MOKKAPATI, Hyderabad (IN)

(21) Appl. No.: 16/655,014

(22) Filed: Oct. 16, 2019

(51) Int. Cl. G06F 3/06; G06F 13/16; G06F 13/42

(52) U.S. Cl. CPC G06F 3/0659; G06F 3/0679; G06F 13/4282; G06F 3/0653; G06F 13/1668; G06F 3/0604

(57) ABSTRACT

In some aspects, the present disclosure provides a method for managing a command queue in a universal flash storage (UFS) host device. The method includes receiving, by a host controller, a plurality of memory commands from a UFS driver, storing, by the host controller, the plurality of memory commands in a command queue, and determining, by the host controller, whether the plurality of memory commands comprises a contiguous set of commands, where a number of the contiguous set of commands is greater than a threshold number of commands, and where each command of the contiguous set of commands has a priority less than a threshold priority.

### BACKGROUND

### Field of the Disclosure

The teachings of the present disclosure relate generally to memory operations, and more particularly, to techniques for efficient command queue management in a universal flash storage (UFS) host device.

### Description of the Related Art

Flash memory (e.g., non-volatile computer storage medium) is a type of memory that can store and hold data without a constant source of power. In contrast, data stored in volatile memory may be erased if power to the memory is lost. Flash memory is a type of non-volatile memory that has become popular in many applications. For example, flash memory devices are used in many communication devices, automobiles, cameras, etc. In some cases, flash memories are required to support a relatively large number of subsystems in a single device. Such subsystems may include a camera, a display, location services, user applications, etc.

Flash memories feature a high storage density and permit block-wise clearing, whereby a rapid and simple programming is ensured. However, making use of such memories in a device with many subsystems requesting memory command execution simultaneously may pose challenges.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Certain aspects provide a method of processing memory commands at a universal flash storage (UFS) host. The method generally includes receiving, by a host controller, a plurality of memory commands from a UFS driver. The method may also include storing, by the host controller, the plurality of memory commands in a command queue. The method may also include determining, by the host controller, whether the plurality of memory commands comprises a contiguous set of commands, where a number of the contiguous set of commands is greater than a threshold number of commands, and where each command of the contiguous set of commands has a priority less than a threshold priority. If the command queue includes the contiguous set of commands, executing, by the host controller, a process comprising: selecting a communication parameter for serving the contiguous set of commands, wherein the communication parameter corresponds to a higher priority than a default priority of a default communication parameter for processing commands having a priority less than the threshold priority; and serving the contiguous set of commands to a UFS device according to the communication parameter.

Certain aspects provide an apparatus for managing memory commands at a UFS host device. The apparatus generally includes a memory, and a processor communicatively coupled to the memory, wherein the processor is configured to receive a plurality of memory commands from a UFS driver. The processor may also be configured to store the plurality of memory commands in a command queue. The processor may also be configured to determine whether the plurality of memory commands comprises a contiguous set of commands, where a number of the contiguous set of commands is greater than a threshold number of commands, and where each command of the contiguous set of commands has a priority less than a threshold priority. If the command queue includes the contiguous set of commands, the processor is further configured to: select a communication parameter for serving the contiguous set of commands, wherein the communication parameter corresponds to a higher priority than a default priority of a default communication parameter for processing commands having a priority less than the threshold priority, and serve the contiguous set of commands to a UFS device according to the communication parameter.

Certain aspects provide a non-transitory computer-readable storage medium that stores instructions that when executed by a processor of a universal flash storage (UFS) host, causes the UFS host to perform a method of command queue management. The method generally includes receiving a plurality of memory commands from a UFS driver. The method may also include storing the plurality of memory commands in a command queue. The method may also include determining whether the plurality of memory commands comprises a contiguous set of commands, where a number of the contiguous set of commands is greater than a threshold number of commands, and where each command of the contiguous set of commands has a priority less than a threshold priority. If the command queue includes the contiguous set of commands, the method may also include executing a process comprising: selecting a communication parameter for serving the contiguous set of commands, wherein the communication parameter corresponds to a higher priority than a default priority of a default communication parameter for processing commands having a priority less than the threshold priority, and serving the contiguous set of commands to a UFS device according to the communication parameter.

Aspects of the present disclosure provide means for, apparatus, processors, and computer-readable mediums for performing techniques and methods for managing memory commands at a UFS host device.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram illustrating an exemplary system-on-chip (SoC) integrated circuit in accordance with certain aspects of the present disclosure.

FIG. 2 is block diagram illustrating an exemplary system including an SoC circuit coupled with a universal flash storage (UFS) device in accordance with certain aspects of the present disclosure.

FIG. 3 is a block diagram conceptually illustrating an example technique for managing a host controller command queue in accordance with certain aspects of the present disclosure.

FIG. 4 is a flow diagram illustrating an example process for managing a host controller command queue in accordance with certain aspects of the present disclosure.

FIG. 5 is a flow diagram illustrating example operations for managing a host controller command queue in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with various other embodiments discussed herein.

The term “system on chip” (SoC) is used herein to refer to a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.), any or all of which may be included in one or more cores.

A number of different types of memories and memory technologies are available or contemplated in the future, all of which are suitable for use with the various aspects of the present disclosure. Such memory technologies/types include phase change memory (PRAM), dynamic random-access memory (DRAM), static random-access memory (SRAM), non-volatile random-access memory (NVRAM), flash memory (e.g., embedded multimedia card (eMMC) flash, flash erasable programmable read only memory (FEPROM)), pseudostatic random-access memory (PSRAM), double data rate synchronous dynamic random-access memory (DDR SDRAM), and other random-access memory (RAM) and read-only memory (ROM) technologies known in the art. A DDR SDRAM memory may be a DDR type 1 SDRAM memory, DDR type 2 SDRAM memory, DDR type 3 SDRAM memory, or a DDR type 4 SDRAM memory.

Each of the above-mentioned memory technologies include, for example, elements suitable for storing instructions, programs, control signals, and/or data for use in or by a computer or other digital electronic device. Any references to terminology and/or technical details related to an individual type of memory, interface, standard or memory technology are for illustrative purposes only, and not intended to limit the scope of the claims to a particular memory system or technology unless specifically recited in the claim language. Mobile computing device architectures have grown in complexity, and now commonly include multiple processor cores, SoCs, co-processors, functional modules including dedicated processors (e.g., communication modem chips, global positioning system (GPS) processors, display processors, etc.), complex memory systems, intricate electrical interconnections (e.g., buses and/or fabrics), and numerous other resources that execute complex and power intensive software applications (e.g., video streaming applications, etc.).

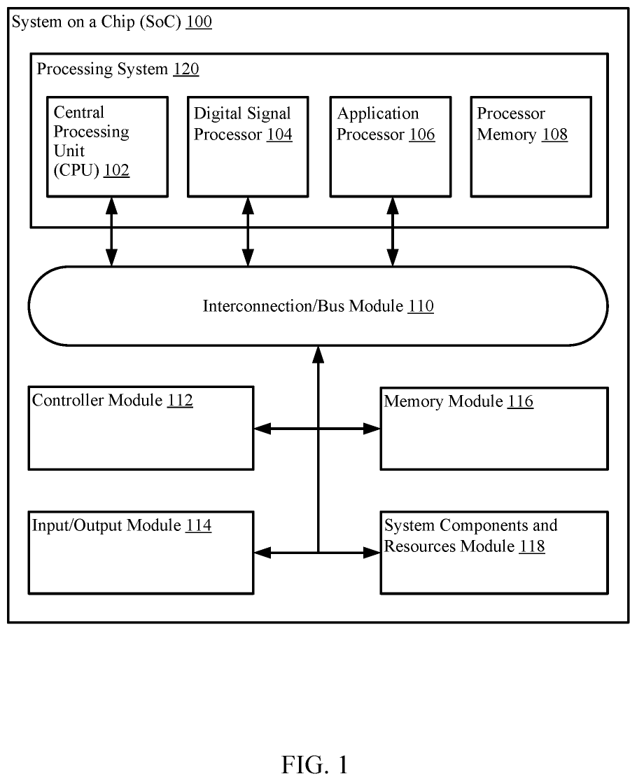

FIG. 1 is a block diagram illustrating an exemplary system-on-chip (SoC) 100 suitable for implementing various aspects of the present disclosure. The SoC 100 includes a processing system 120 that includes a plurality of heterogeneous processors such as a central processing unit (CPU) 102, a digital signal processor 104, an application processor 106, and a processor memory 108. The processing system 120 may include one or more cores, and each processor/core may perform operations independent of the other processors/cores. The processors 102, 104, and 106 may be organized in close proximity to one another (e.g., on a single substrate, die, integrated chip, etc.) so that they may operate at a much higher frequency/clock-rate than would be possible if the signals were to travel off-chip. The proximity of the cores may also allow for the sharing of on-chip memory and resources (e.g., voltage rail), as well as for more coordinated cooperation between cores.

The processing system 120 is interconnected with one or more controller module(s) 112, input/output (I/O) module(s) 114, memory module(s) 116, and system component and resources module(s) 118 via a bus module 110 which may include an array of reconfigurable logic gates and/or implement bus architecture (e.g., CoreConnect, advanced microcontroller bus architecture (AMBA), etc.). Bus module 110 communications may be provided by advanced interconnects, such as high performance networks on chip (NoCs). The interconnection/bus module 110 may include or provide a bus mastering system configured to grant SoC components (e.g., processors, peripherals, etc.) exclusive control of the bus (e.g., to transfer data in burst mode, block transfer mode, etc.) for a set duration, number of operations, number of bytes, etc. In some cases, the bus module 110 may implement an arbitration scheme to prevent multiple master components from attempting to drive the bus simultaneously.

The controller module 112 may be a specialized hardware module configured to manage the flow of data to and from the memory module 116, the processor memory 108, or a memory device located off-chip (e.g., a flash memory device). In some examples, the memory module may include a UFS host device configured to receive various memory commands from an application layer, and address and communicate the memory commands to a memory device. The controller module 112 may comprise one or more processors configured to perform operations disclosed herein. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The I/O module 114 is configured for communicating with resources external to the SoC. For example, the I/O module 114 includes an input/output interface (e.g., a bus architecture or interconnect) or a hardware design for performing specific functions (e.g., a memory, a wireless device, and a digital signal processor). In some examples, the I/O module includes circuitry to interface with peripheral devices, such as a memory device located off-chip.

The memory module 116 is a computer-readable storage medium implemented in the SoC 100. The memory module 116 may provide non-volatile storage for one or more of the processing system 120, controller module 112, I/O module 114, or the system components and resources module 118. The memory module 116 may include a cache memory to provide temporary storage of information to enhance processing speed of the SoC 100.

The SoC 100 may include a system components and resources module 118 for managing sensor data, analog-to-digital conversions, wireless data transmissions, and for performing other specialized operations (e.g., supporting interoperability between different devices). System components and resources module 118 may also include components such as voltage regulators, oscillators, phase-locked loops, peripheral bridges, data controllers, system controllers, access ports, timers, and other similar components used to support the processors and software clients running on the computing device. The system components and resources 118 may also include circuitry for interfacing with peripheral devices, such as cameras, electronic displays, wireless communication devices, external memory chips, etc.

In certain aspects, a UFS host device may serve multiple applications and/or masters (e.g., one or more processors of the processing system 120) by receiving memory commands from the masters and serving the commands to a memory device (e.g., memory module 116). However, in some cases, several applications may compete for memory access at the same time, resulting in a congested queue of memory commands waiting to be executed. In some examples, executing the queue of memory commands at a default data rate results in slow performance of applications and reduced efficiency at the host device. Thus, there is a need to effectively manage a command queue at the host device in order to improve efficiency of the SoC.

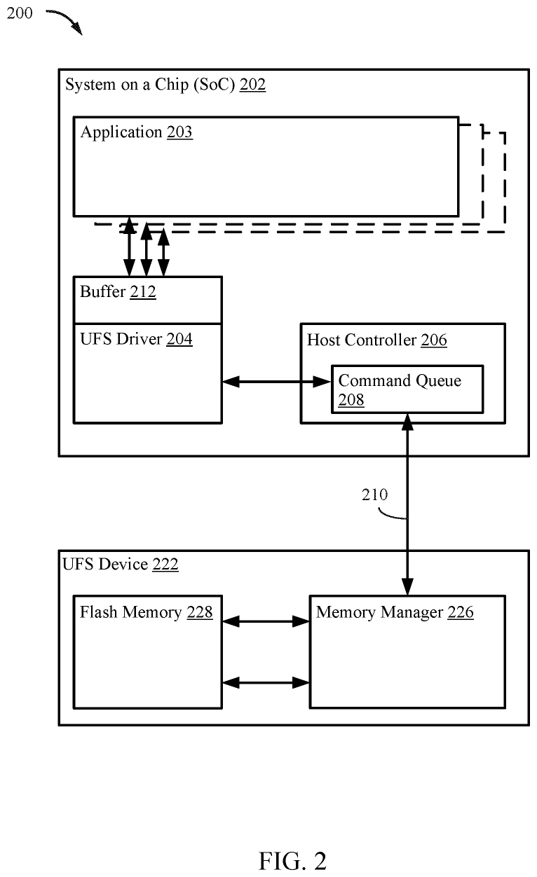

FIG. 2 is block diagram illustrating an exemplary memory system 200 including an SoC 202 coupled with an off-chip UFS device 222 (e.g., memory module 116 of FIG. 1) in accordance with certain aspects of the present disclosure. Of course, the off-chip UFS device configuration illustrated in FIG. 2 is not necessarily the only configuration that may be utilized between an SoC and a UFS device, and those of ordinary skill in the art will recognize that other configurations may be utilized in addition to those illustrated, such as an on-chip UFS device located on the SoC.

As shown in FIG. 2, the SoC 202 includes one or more applications 203 communicatively coupled to a UFS driver 204 (e.g., part of the control module 112 of FIG. 1). Applications may include operations being performed on a processing system (e.g., processing system 120 of FIG. 1). The UFS driver 204 may be configured to receive memory commands and tag each memory command with an indication of the priority associated with each command. Memory commands from an application generally relate to operations in memory such as input/output (I/O) operations (e.g., read and write operations).

The host controller 206 (e.g., control module 112 of FIG. 1) includes a command queue 208 configured to temporarily store memory commands received from the UFS driver 204. In some examples, the command queue 208 is a buffer that can store up to 32 memory commands before the commands are transferred to the UFS memory device for execution. In some embodiments, when the host controller 206 receives a memory command from the UFS driver 204, the host controller 206 notes the priority indication of the memory command and puts the memory command in the command queue 208. In some examples, the host controller 206 includes a register configured to store an indication of the priority of each memory command in the command queue 208. In this way, the host controller 206 can maintain a log of the priority of each memory command held in the command queue 208.

The host controller 206 is communicatively coupled to a memory manager 226 (e.g., part of the memory module 116 of FIG. 1) of the UFS device 222. The host controller 206 is configured to cooperate with the memory manager 226 to exchange data and commands via an interface 210. In one embodiment, interface 210 is a high-speed serial interface having a plurality of lanes, with each lane configured for electrical transmission of data. In some examples, each lane is a unidirectional, single-signal, physical transmission channel. Accordingly each lane may have its own physical interface between the host controller 206 and the memory manager 226. The rate at which data is transmitted over the plurality of lanes is dependent on which gear of a plurality of gears is being used. In some examples, each gear corresponds to a different data rate. Table 1 below provides an example of a plurality of gears and corresponding data rates:

TABLE 1

| | |
|---|---|
| Data Rate Per Lane (Gbps) | Gear |

| | | |
|---|---|---|
| 1.5 | Gbps | HS-G1 (first gear) |
| 3 | Gbps | HS-G2 (second gear) |
| 6 | Gbps | HS-G3 (third gear) |
| 11.7 | Gbps | HS-G4 (fourth gear) |

Host controller 206 is configured to select the gear and number of lanes that the UFS device 222 uses for each memory command according to one or more parameters, including the priority of the memory command. In one embodiment, the commands and signaling protocol are compatible with one or more standards, for example, with non-volatile memory express (NVMe) or the small computer system interface (SCSI) (in the case of commands) and peripheral component interconnect express (PCIe) or serial-attached SCSI/serial ATA (SAS/SATA) (in the case of signaling formats).

In addition to the memory manager 226, the UFS device 222 includes a flash memory 228 communicatively coupled to the memory manager 226. Flash memory 228 generally includes an array of memory cells and control circuitry controlled by the memory manager 226. Flash memory 228 may include one or more subdivisions of memory cells for which subdivision-specific usage data should be tracked by the memory manager 226.

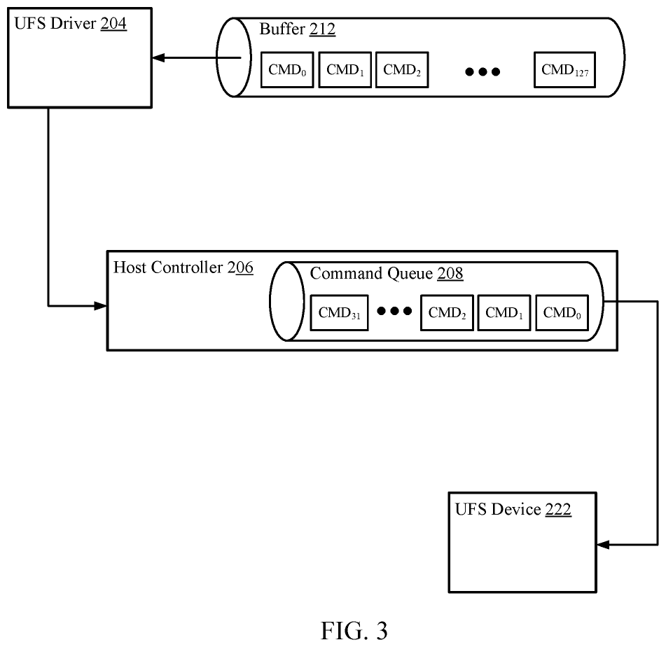

FIG. 3 is a block diagram conceptually illustrating an example technique for managing a host controller command queue. FIG. 3 shows the buffer 212 at maximum capacity, having a total of 128 memory commands stored and ready for the UFS driver 204 to communicate to the host controller 206. The command queue 208 of the host controller 206 is also at maximum capacity, having a total of 32 memory commands ready to be sent to the UFS device 222.

In some examples, the UFS driver 204 is configured to receive memory commands from the buffer 212, and then tag each of the received commands with an indication of a priority corresponding to each command. In some examples, the UFS driver 204 tags the memory command by setting a value in a metadata field of the command, wherein the value is configured to indicate the priority associated with the command.

In some examples, when the host controller 206 receives the tagged memory commands from the UFS driver 204, the host controller 206 reads the tagged priority of each command and logs the priority for each command that it inputs into the command queue 208. In some examples, the host controller 206 maintains a register or other suitable digital storage element, that includes a number of bits equal to or greater than the memory command capacity of the command queue 208. In this way, the host controller can log and store the corresponding priority of each memory command in the command queue 208 as well as the order or location of each command in the command queue.

In certain aspects, the host controller is configured to process the memory commands in the command queue 208 by determining whether the plurality of memory commands include a contiguous set of commands having a low priority, meaning they are stored adjacent to one another, in order, or contiguously in the command queue 208. For example, the host controller 206 may determine whether two or more memory commands in the command queue 208 form a series of low priority commands. In some examples, the host controller 206 is configured to determine whether the memory commands in a contiguous set of commands is greater than a threshold number of commands. For example, the host controller 206 may determine whether a contiguous set of memory commands having a low priority is greater than 4. Notably, any suitable number of memory commands can be used as a threshold number of commands and be within the scope of this disclosure.

In some examples, the host controller 206 is configured to determine whether the plurality of memory commands forms a contiguous set of commands by monitoring the register or digital storage element where both the priority and the location within the command queue 208 of each of the memory commands is logged. Accordingly, the host controller 206 can determine whether the command queue 208 contains a contiguous set of memory commands all sharing a low priority.

In certain aspects, the host controller 206 may also be configured to determine whether each of the commands in the command queue 208 has a priority that is lower than a threshold priority. In some examples, the priority of each memory command may be based on a range of multiple priorities. For example, one or more of the memory commands may be considered a “low” priority command if they have a priority that is lower than a threshold priority. Thus, low priority commands may be determined to be low relative to other “high” priority commands depending on the threshold priority.

If the host controller 206 determines that the command queue 208 includes a contiguous set of low priority memory commands, the host controller 206 may execute a process configured to reduce the congestion caused by memory command backup at the buffer 212 and the host controller 206. In certain aspects, the process includes selecting a communication parameter for serving the contiguous set of commands. In some examples, the process is configured to select a communication parameter that corresponds to a higher priority memory command relative to a default priority of a default communication parameter for processing commands having a priority less than the threshold priority.

For example, the host controller 206 may communicate a command having a low priority, or a priority less than the threshold priority, using a single lane and the first gear (HS-G1). In another example, the host controller 206 may communicate a command having a high priority, or a priority greater than the threshold priority, using one or more lanes (e.g., lane 1 and lane 2) and any one of the second gear (HS-G2), the third gear (HS-G3), or the fourth gear (HS-G4). Accordingly, commands having a higher priority can be served to the UFS device 222 at a higher data rate and using more than one lane relative commands with a lower priority.

In certain aspects, the communication parameter includes a combination of: (i) a gear of a plurality of gears, and (ii) one or more lanes of a plurality of lanes. In some examples, each of the plurality of gears corresponds to a data rate for serving the contiguous set of commands, and each of the plurality of lanes corresponds to a physical interface or path (e.g., serial interface).

In some examples, the host controller 206 is configured to select the communication parameter by determining which gear and lane combination it can serve the contiguous set of memory commands to the UFS device 222 at the highest data rate relative to other gear and lane combinations.

In some examples, the host controller 206 may also be configured to restrict the frequency by which it executes the process. For example, if the host controller 206 is continuously receiving memory commands that are a low priority relative to the threshold priority, then continuously serving the low priority commands at the highest available data rate may result in high power consumption by the memory system. Thus, in certain aspects, the host controller 206 may be configured to set a bit in a register if the host controller 206 determines that the plurality of memory commands in the command queue 208 include a contiguous set of low priority commands, and determines to execute the process. In some examples, prior to executing the process, the host controller 206 may determine a number of bits in the register, where the number of bits indicate a number of times the process has been executed consecutively. The host controller 206 may then determine whether the number of bits satisfies an equality condition. For example, the host controller 206 may determine whether the number of bits is greater of lower than a threshold value. If the number of bits is greater than the threshold value, then the host controller 206 may refrain from executing the process, and instead process the memory commands according to a default gear and lane combination corresponding to priority associated with each command. If, however, the number of bits is less than the threshold value, then the host controller 206 may proceed to execute the process. In some examples, the host controller 206 may clear the register if the command queue 208 is filled with a plurality of memory commands without a contiguous set of low priority commands.

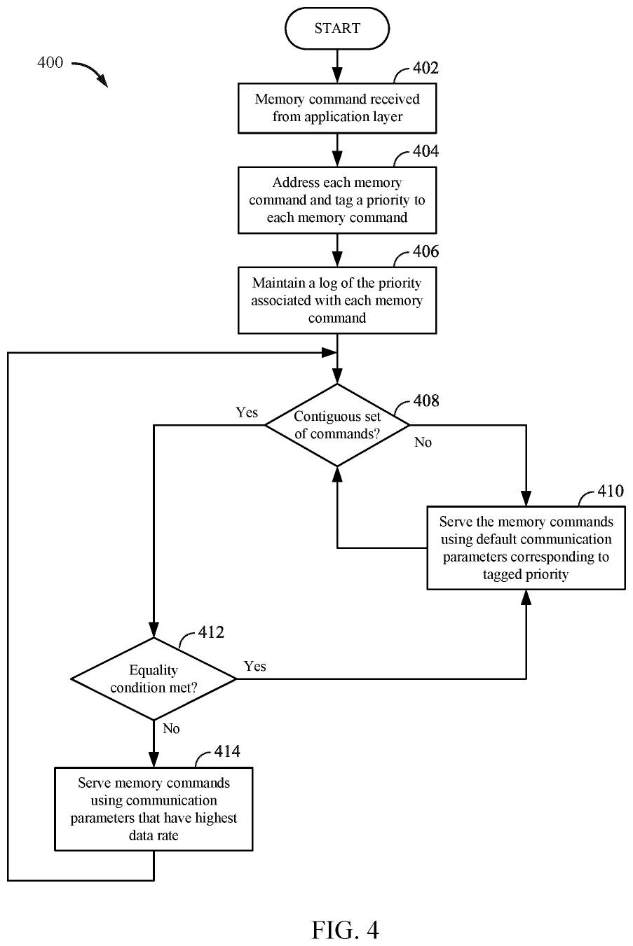

FIG. 4 is a flow chart illustrating example operations 400 for managing a host controller command queue. The operations 400 may be performed, for example, by a memory 116 (e.g., such as the memory module 116 of the SoC 100) or a host controller and a UFS host driver (e.g., such as the host controller 206 and the UFS host driver 204 of the SoC 202). Operations 400 may be implemented as software components that are executed and run on one or more processors (e.g., processing system 120 of FIG. 1). In certain aspects, the transmission and/or reception of data by various hardware components may be implemented via a bus interface (e.g., bus module 110 of FIG. 1).

In this example, the operations 400 start at a first step 402 where a UFS driver (e.g., UFS driver 204 of FIGS. 2 and 3) receives a plurality of memory commands from an application layer. The operations 400 then proceed to step 404, where the UFS driver or the host controller (e.g., host controller 206 from FIGS. 2 and 3) address each memory command and tag a priority to each memory command.

The operations then proceed to step 406, where the host controller maintains a log of the priority associated with each memory command that is entered into a command queue (e.g., command queue 208 of FIGS. 2 and 3). The operations 400 then proceed to step 408 where the host controller determines whether the command queue contains a contiguous set of commands that have a priority less than the threshold priority. If the command queue does not include the contiguous set of commands, the operations 400 proceed to step 410, where the host controller serves the memory commands using default communication parameters corresponding to the tagged priority. The operations 400 then proceed back to step 408, wherein the host controller determines whether a next set of memory commands include a contiguous set of commands.

If the command queue includes the contiguous set of commands, the operations 400 proceed to step 412, where the host controller determines whether a value in a register meets an equality condition, where the value in the register is configured to indicate a number of consecutive times a process has been executed. If the equality condition is not satisfied, the process 400 proceeds to step 410, where the memory commands are served using default communication parameters corresponding to the priority of the commands.

If the equality condition is satisfied, the process 400 proceeds to step 414, where the host controller serves the memory commands using communication parameters that provide the highest data rate for sending the commands to a UFS device or a most rapid means for communicating the commands to the UFS device. The process 400 then proceeds back to step 408, wherein the host controller determines whether a next set of memory commands include a contiguous set of commands. The process 400 then proceeds back to step 408, wherein the host controller determines whether a next set of memory commands include a contiguous set of commands.

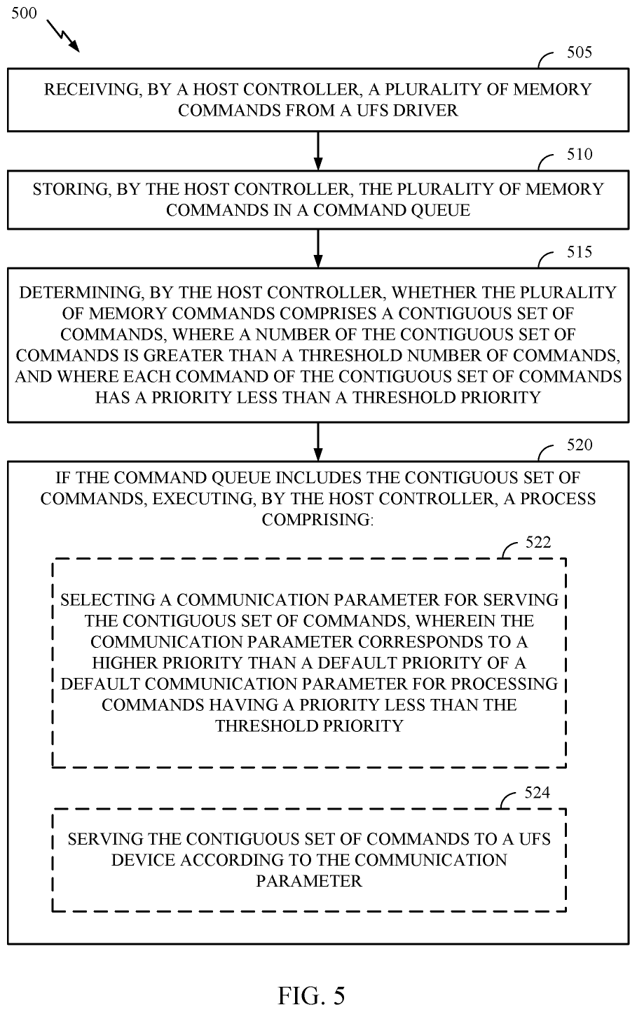

FIG. 5 is a flow diagram illustrating example operations 500 for managing a host controller command queue. The operations 500 may be performed, for example, by a memory 116 (e.g., such as the memory module 116 of the SoC 100) or a host controller and a UFS host driver (e.g., such as the host controller 206 and the UFS host driver 204 of the SoC 202). Operations 500 may be implemented as software components that are executed and run on one or more processors (e.g., processing system 120 of FIG. 1). In certain aspects, the transmission and/or reception of data by various hardware components may be implemented via a bus interface (e.g., bus module 110 of FIG. 1).

The operations 500 may begin, at block 505, by receiving, by a host controller, a plurality of memory commands from a UFS driver.

The operations 500 proceed to block 510 by storing, by the host controller, the plurality of memory commands in a command queue.

The operations 500 proceed to block 515 by determining, by the host controller, whether the plurality of memory commands comprises a contiguous set of commands, where a number of the contiguous set of commands is greater than a threshold number of commands, and where each command of the contiguous set of commands has a priority less than a threshold priority.

The operations 500 proceed to block 520 by executing, by the host controller a process, if the command queue includes the contiguous set of commands, wherein the process includes: selecting, at block 522, a communication parameter for serving the contiguous set of commands, wherein the communication parameter corresponds to a higher priority than a default priority of a default communication parameter for processing commands having a priority less than the threshold priority. The process also includes serving, at block 524 the contiguous set of commands to a UFS device according to the communication parameter.

In certain aspects, the operations 500 include tagging, by the UFS driver, each of the plurality of memory commands with an indication of a corresponding priority.

In certain aspects, determining whether the plurality of memory commands comprises the contiguous set of commands comprises: (i) storing, by the host controller, the priority of each of the plurality of memory commands in a digital storage element, and (ii) monitoring, by the host controller, the digital storage element to determine whether the plurality of memory commands comprises the contiguous set of commands.

In certain aspects, the communication parameter comprises a combination of a first gear of a plurality of gears, wherein each of the plurality of gears corresponds to a data rate for serving the contiguous set of commands, and a first lane of a plurality of lanes for serving the contiguous set of commands, wherein each of the plurality of lanes is a serial interface.

In certain aspects, selecting the communication parameter includes determining which gear of the plurality of gears is configured to serve the contiguous set of commands at the highest data rate relative to other gears, and determining a number of lanes to use to serve the contiguous set of commands.

In certain aspects, the operations 500 include setting a bit in a register if the plurality of memory commands comprises the contiguous set of commands.

In certain aspects, the operations 500 include determining a number of bits set in the register, determining whether the number satisfies an equality condition, and if the number satisfies the equality condition, selecting the default communication parameter for serving the contiguous set of commands.

### ADDITIONAL CONSIDERATIONS

In some configurations, the term(s) ‘communicate,’ ‘communicating,’ and/or ‘communication’ may refer to ‘receive,’ ‘receiving,’ ‘reception,’ and/or other related or suitable aspects without necessarily deviating from the scope of the present disclosure. In some configurations, the term(s) ‘communicate,’ ‘communicating,’ may refer to ‘transmit,’ ‘transmitting,’ ‘transmission,’ and/or other related or suitable aspects without necessarily deviating from the scope of the present disclosure.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits.

One or more of the components, steps, features and/or functions illustrated herein may be rearranged and/or combined into a single component, step, feature or function or embodied in several components, steps, or functions. Additional elements, components, steps, and/or functions may also be added without departing from novel features disclosed herein. The apparatus, devices, and/or components illustrated herein may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for” or simply as a “block” illustrated in a figure.

These apparatus and methods described in the detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software, firmware, middleware, microcode, hardware description language, or otherwise. The software may be stored on non-transitory computer-readable medium included in the processing system.

Accordingly, in one or more exemplary embodiments, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

What is claimed is:

1. A method for processing memory commands at a universal flash storage (UFS) host, comprising:
receiving, by a host controller, a plurality of memory commands from a UFS driver;
storing, by the host controller, the plurality of memory commands in a command queue;
determining, by the host controller, whether the plurality of memory commands comprises a contiguous set of commands, where a number of the contiguous set of commands is greater than a threshold number of commands, and where each command of the contiguous set of commands has a priority less than a threshold priority;
if the command queue includes the contiguous set of commands, executing, by the host controller, a process comprising:
selecting a communication parameter for serving the contiguous set of commands, wherein the communication parameter corresponds to a higher priority than a default priority of a default communication parameter for processing commands having a priority less than the threshold priority; and
serving the contiguous set of commands to a UFS device according to the communication parameter.

2. The method of claim 1, further comprising tagging, by the UFS driver, each of the plurality of memory commands with an indication of a corresponding priority.

3. The method of claim 2, wherein determining whether the plurality of memory commands comprises the contiguous set of commands comprises:
storing, by the host controller, the priority of each of the plurality of memory commands in a digital storage element; and
monitoring, by the host controller, the digital storage element to determine whether the plurality of memory commands comprises the contiguous set of commands.

4. The method of claim 1, wherein the communication parameter comprises a combination of:
a first gear of a plurality of gears, wherein each of the plurality of gears corresponds to a data rate for serving the contiguous set of commands; and
a first lane of a plurality of lanes for serving the contiguous set of commands, wherein each of the plurality of lanes is a serial interface.

5. The method of claim 4, wherein selecting the communication parameter comprises:
determining which gear of the plurality of gears is configured to serve the contiguous set of commands at the highest data rate relative to other gears; and
determining a number of lanes to use to serve the contiguous set of commands.

6. The method of claim 1, further comprising setting a bit in a register if the plurality of memory commands comprises the contiguous set of commands.

7. The method of claim 6, further comprising:
determining a number of bits set in the register;
determining whether the number satisfies an equality condition; and
if the number satisfies the equality condition, selecting the default communication parameter for serving the contiguous set of commands.

8. An apparatus, comprising:
a memory; and
a processor communicatively coupled to the memory, wherein the processor is configured to:
receive a plurality of memory commands from a UFS driver;
store the plurality of memory commands in a command queue;
determine whether the plurality of memory commands comprises a contiguous set of commands, where a number of the contiguous set of commands is greater than a threshold number of commands, and where each command of the contiguous set of commands has a priority less than a threshold priority;
if the command queue includes the contiguous set of commands, the processor is further configured to:
select a communication parameter for serving the contiguous set of commands, wherein the communication parameter corresponds to a higher priority than a default priority of a default communication parameter for processing commands having a priority less than the threshold priority; and
serve the contiguous set of commands to a UFS device according to the communication parameter.

9. The apparatus of claim 8, wherein the processor is further configured to tag each of the plurality of memory commands with an indication of a corresponding priority.

10. The apparatus of claim 9, wherein the processor, being configured to determine whether the plurality of memory commands comprises the contiguous set of commands, is further configured to:
store the priority of each of the plurality of memory commands in a digital storage element; and
monitor the digital storage element to determine whether the plurality of memory commands comprises the contiguous set of commands.

11. The apparatus of claim 8, wherein the communication parameter comprises a combination of:
a first gear of a plurality of gears, wherein each of the plurality of gears corresponds to a data rate for serving the contiguous set of commands; and
a first lane of a plurality of lanes for serving the contiguous set of commands, wherein each of the plurality of lanes is a serial interface.

12. The apparatus of claim 11, wherein the processor, being configured to select the communication parameter, is further configured to:
determine which gear of the plurality of gears is configured to serve the contiguous set of commands at the highest data rate relative to other gears; and
determine a number of lanes to use to serve the contiguous set of commands.

13. The apparatus of claim 8, wherein the processor is further configured to set a bit in a register if the plurality of memory commands comprises the contiguous set of commands.

14. The apparatus of claim 13, wherein the processor is further configured to:
determine a number of bits set in the register;
determine whether the number satisfies an equality condition; and
if the number satisfies the equality condition, select the default communication parameter for serving the contiguous set of commands.

15. A non-transitory computer-readable storage medium that stores instructions that when executed by a processor of a universal flash storage (UFS) host, causes the UFS host to perform a method of command queue management, comprising:
receiving a plurality of memory commands from a UFS driver;
storing the plurality of memory commands in a command queue;
determining whether the plurality of memory commands comprises a contiguous set of commands, where a number of the contiguous set of commands is greater than a threshold number of commands, and where each command of the contiguous set of commands has a priority less than a threshold priority;
if the command queue includes the contiguous set of commands, executing a process comprising:
selecting a communication parameter for serving the contiguous set of commands, wherein the communication parameter corresponds to a higher priority than a default priority of a default communication parameter for processing commands having a priority less than the threshold priority; and
serving the contiguous set of commands to a UFS device according to the communication parameter.

16. The non-transitory computer-readable medium of claim 15, wherein the method further comprises tagging each of the plurality of memory commands with an indication of a corresponding priority.

17. The non-transitory computer-readable medium of claim 16, wherein determining whether the plurality of memory commands comprises the contiguous set of commands comprises:
storing, by the host controller, the priority of each of the plurality of memory commands in a digital storage element; and
monitoring, by the host controller, the digital storage element to determine whether the plurality of memory commands comprises the contiguous set of commands.

18. The non-transitory computer-readable medium of claim 15, wherein the communication parameter comprises a combination of:
a first gear of a plurality of gears, wherein each of the plurality of gears corresponds to a data rate for serving the contiguous set of commands; and
a first lane of a plurality of lanes for serving the contiguous set of commands, wherein each of the plurality of lanes is a serial interface.

19. The non-transitory computer-readable medium of claim 18, wherein selecting the communication parameter comprises:
determining which gear of the plurality of gears is configured to serve the contiguous set of commands at the highest data rate relative to other gears; and
determining a number of lanes to use to serve the contiguous set of commands.

20. The non-transitory computer-readable medium of claim 15, further comprising:
setting a bit in a register if the plurality of memory commands comprises the contiguous set of commands;
determining a number of bits set in the register;
determining whether the number satisfies an equality condition; and
if the number satisfies the equality condition, selecting the default communication parameter for serving the contiguous set of commands.
